(19) United States
(12) Patent Application Publication
(10) Pub. No.: US 2008/0225902 A1
(43) Pub. Date: Sep. 18, 2008

(54) MoCA-compliant multiplexer circuit

(75) Inventors: Nan-Hsiang Chung, Fang-Shan City (TW); Shuo-Chao Huang, Ta-Liao Hsiang (TW)

Correspondence Address: BANNER & WITCOFF, LTD., 1100 13th STREET, N.W., SUITE 1200, WASHINGTON, DC, 20005-4051, US

(73) Assignee: YCL Electronics Co., Ltd., Feng Shan City (TW)

(21) Appl. No.: 11/717,008

(22) Filed: Mar. 13, 2007

(51) Int. Cl. H04J 3/02

(52) U.S. Cl. 370/537

(57) ABSTRACT

A multiplexer circuit complies with Multimedia over Coax Alliance (MoCA) specifications and is adapted to be disposed between an input end and an output end. The multiplexer circuit includes a first adapter and a second adapter. The first adapter includes a first high pass filter and a first low pass filter connected in series to the first high pass filter. The second adapter is connected in parallel to the first adapter, and includes a second low pass filter and a second high pass filter connected in series to the second low pass filter. The first high pass filter and the second low pass filter are adapted to be disposed closer to the input end compared to the first low pass filter and the second high pass filter.

### BACKGROUND OF THE INVENTION

1. Field of the Invention

The invention relates to a multiplexer circuit, more particularly to a multiplexer circuit complying with Multimedia over Coax Alliance (MoCA) specifications.

2. Description of the Related Art

For years, Ethernet cables are primarily used in digital home wiring for transmission of audio-video signals and digital data among rooms in a premise and for connections among equipments, such as multimedia systems automatic control systems, security systems, etc., in the premise.

However, Ethernet infrastructure has a disadvantage in that, when wiring an existing building structure, boring through walls inevitably damages the building structure, and the wiring operation may be more difficult to conduct compared to constructing a new structure. Moreover, the skills of professionals, instead of ordinary technicians, are needed when installing Ethernet cables, thereby resulting in higher installation costs.

Therefore, new technologies, such as the HomePlug Power Alliance (HomePlug AV) specifications and the Multimedia over Coax Alliance (MoCA) specifications, have been developed to overcome the aforesaid disadvantages of Ethernet cables. Instead of installing a new wiring network system, the HomePlug Av and MoCA specifications utilize transmission lines commonly found in existing building structures for digital signal transmission. In particular, the HomePlug Av specifications require use of ordinary transmission lines such as power lines from power companies, whereas the MoCA specifications require use of coaxial cable lines. According to the MoCA specifications, by coupling a MoCA-compliant multiplexer or adaptor to a coaxial cable, the coaxial cable can be used for telephone service and computer digital network applications and can provide sufficient bandwidth to satisfy remote control of audio-video data streams.

Referring to FIG. 1, a conventional MoCA-compliant multiplexer circuit 1 is shown to be adapted to be disposed between an input end (INPUT) and a pair of output ends (OUTPUT). The multiplexer circuit 1 includes a first high pass filter (HPF1) connected to the input end (INPUT), a first lowpass filter (LPF1) connected in series between the first high pass filter (HPF1) and one of the output ends (OUTPUT), a second high pass filter (HPF2) connected to the input end (INPUT), and a second low pass filter (LPF2) connected in series between the second high pass filter (HPF2) and the other one of the output ends (OUTPUT). The impedance at each of the input end (INPUT) and the output ends (OUTPUT) is 75 ohms.

FIG. 2 is a plot of frequency versus noise response of the multiplexer circuit 1. It is noted that noise dB values fluctuate within a frequency range of 0 to 3 GHz. According to the MoCA specifications, better signal isolation is required for frequency ranges of 1125 MHz to 1525 MHz and 975 MHz to 1025 MHz.

However, as shown in FIG. 2, in the frequency range of 975 MHz to 1525 MHz, noise dB values range from −35 dB to −105 dB. This implies that isolation at the output ends (OUTPUT) is not good. In the conventional multiplexer circuit 1, a signal at the input end (INPUT) is fed simultaneously to the first high pass filter (HPF1) and the second high pass filter (HPF2). Interaction between the first high pass filter (HPF1) and the second high pass filter (HPF2) causes severe signal interference that affects clarity of signals carried over a same coaxial cable for telephone service and computer digital network applications and that results in inefficient use of frequency bandwidth that affects data streams for audio-video signals and for remote control.

### SUMMARY OF THE INVENTION

Therefore, the object of the present invention is to provide a multiplexer circuit that can overcome the above drawbacks associated with the prior art. Accordingly, there is provided a multiplexer circuit complying with Multimedia over Coax Alliance (MoCA) specifications and adapted to be disposed between an input end and an output end. The multiplexer circuit comprises a first adapter and a second adapter. The first adapter includes a first high pass filter and a first low pass filter connected in series to the first high pass filter. The second adapter is connected in parallel to the first adapter, and includes a second low pass filter and a second high pass filter connected in series to the second low pass filter. The first high pass filter and the second low pass filter are adapted to be disposed closer to the input end compared to the first low pass filter and the second high pass filter.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit diagram of a conventional MoCA-compliant multiplexer circuit;

FIG. 2 is a plot of frequency versus noise response of the conventional MoCA-compliant multiplexer circuit;

FIG. 3 is a circuit diagram of the preferred embodiment of a MoCA-compliant multiplexer circuit according to the present invention; and

FIG. 4 is a plot of frequency versus noise response of the preferred embodiment.

### DETAILED DESCRIPTION OF THE PREFERRED EMBODIMENT

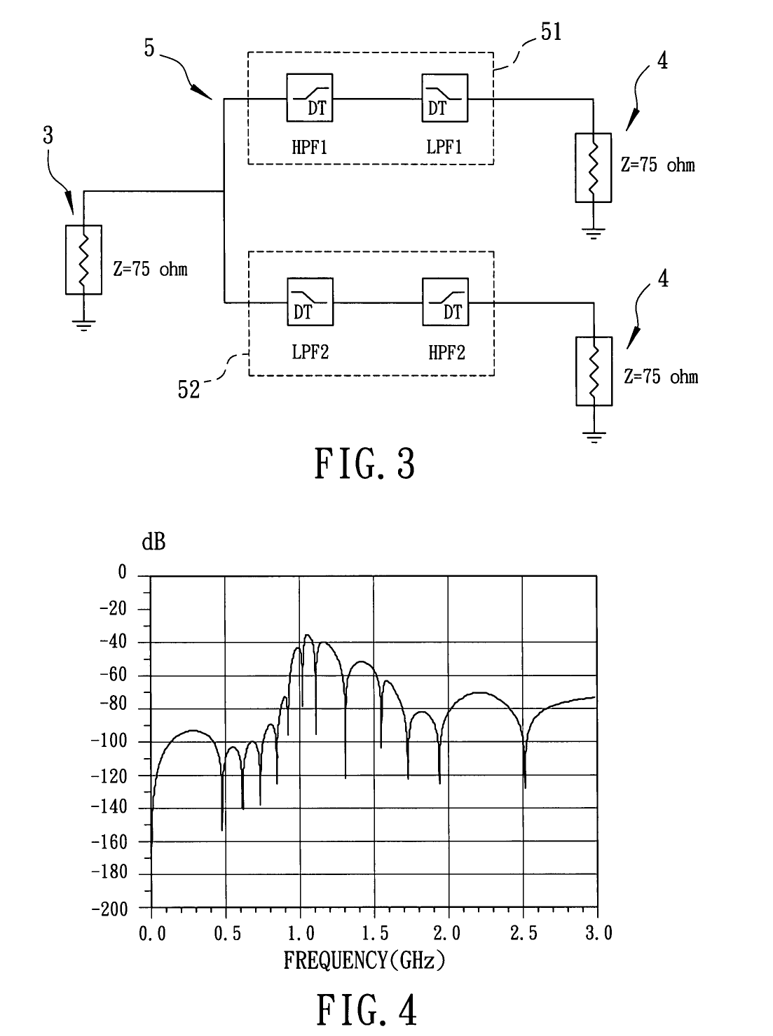

Referring to FIG. 3, the preferred embodiment of a multiplexer circuit 5 complying with MoCA specifications according to the present invention is shown to be adapted to be disposed between an input end 3 and a pair of output ends 4. The multiplexer circuit 5 comprises a first adapter 51 and a second adapter 52. The first adapter 51 includes a first high pass filter (HPF1) connected to the input end 3, and a first low pass filter (LPF1) connected in series between the first high pass filter (HPF1) and one of the output ends 4. The second adapter 52 is connected in parallel to the first adapter 51, and includes a second low pass filter (LPF2) connected to the input end 3, and a second high pass filter (HPF2) connected in series between the second low pass filter (LPF2) and the other one of the output ends 4. Therefore, the first high pass filter (HPF1) and the second lowpass filter (LPF2) are disposed closer to the input end 3 compared to the first low pass filter (LPF1) and the second high pass filter (HPF2), whereas the first low pass filter (LPF1) and the second high pass filter (HPF2) are disposed closer to the output ends 4 compared to the first high pass filter (HPF1) and the second low pass filter (LPF2). Preferably, impedance at each of the input end 3 and the output ends 4 ranges between 70 and 80 ohms. In this embodiment, the impedance is 75 ohms.

Since the first high pass filter (HPF1) and the second low pass filter (LPF2) are disposed closer to the input end 3, the first high pass filter (HPF1) and the second low pass filter (LPF2) can interact to improve isolation between signals passing through the first and second adapters 51, 52, thereby improving signal transmission quality and ensuring operational stability of equipments connected to the multiplexer circuit 5.

FIG. 4 is a plot of frequency versus noise response of the preferred embodiment within a frequency range of 0 to 3 GHz. As mentioned hereinabove, better signal isolation is required by the MoCA specifications for frequency ranges of 1125 MHz to 1525 MHz and 975 MHz to 1025 MHz.

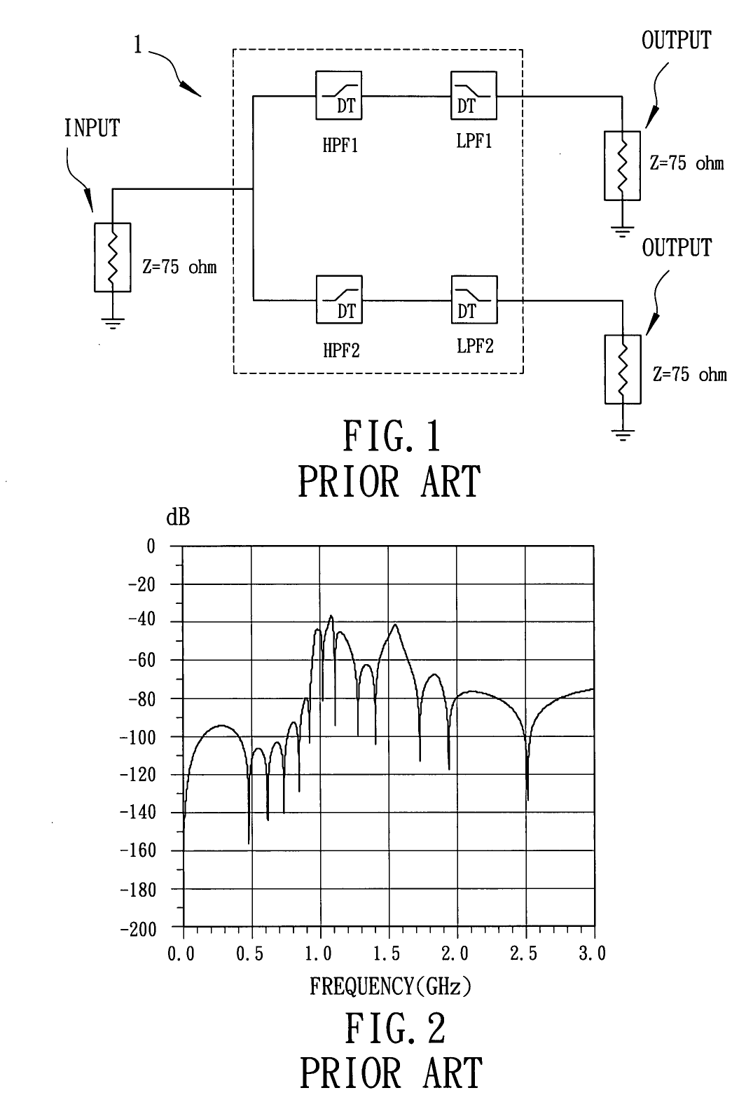

As shown in FIG. 4, noise dB values range from −35 dB to −50 dB in the frequency range of 975 MHz to 1525 MHz. Comparing the plots of FIGS. 2 and 4, it is apparent that the MoCA-compliant multiplexer circuit 5 of this invention provides better isolation in the frequency range between 975 MHz and 1525 MHz, i.e., the isolation effect between voice and data streams is better, compared to the conventional multiplexer circuit of FIG. 1.

In the multiplexer circuit 5 of this invention, a signal at the input end 3 is fed simultaneously to the first high pass filter (HPF1) and the second low pass filter (LPF2). Interaction between the first high pass filter (HPF1) and the second low pass filter (LPF2) causes most high frequency signals to pass through the first adapter 51 and most low frequency signals to pass through the second adapter 52 such that signal interference between the first and second adapters 51, 52 is significantly reduced. Since the range of noise fluctuation is 15 dB, noise of signals carried over a same coaxial cable for telephone service and computer digital network applications is reduced, and the frequency bandwidth is effectively utilized so as not to affect clarity of data streams for audio-video signals and for remote control.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multiplexer circuit complying with Multimedia over Coax Alliance (MoCA) specifications and adapted to be disposed between an input end and an output end, said multiplexer circuit comprising:
a first adapter including a first high pass filter and a first low pass filter connected in series to said first high pass filter; and
a second adapter connected in parallel to said first adapter, and including a second low pass filter and a second high pass filter connected in series to said second low pass filter;
wherein said first high pass filter and said second low pass filter are adapted to be disposed closer to the input end compared to said first low pass filter and said second high pass filter.

2. The multiplexer circuit as claimed in claim 1, wherein impedance at each of the input and output ends ranges between 70 and 80 ohms.
